(19) United States
(12) Patent Application Publication
(10) Pub. No.: US 2025/0110805 A1
(43) Pub. Date: Apr. 3, 2025

(54) OPTIMIZING THROUGHPUT OF MACHINE-LEARNING APPLICATIONS

(71) Applicant: THE TORONTO-DOMINION BANK, TORONTO (CA)

(72) Inventors: Peter Starszyk, Waterloo (CA); Devinder Kumar, TORONTO (CA)

(21) Appl. No.: 18/903,771

(22) Filed: Oct. 1, 2024

Related U.S. Application Data
(60) Provisional application No. 63/541,963, filed on Oct. 2, 2023.

(51) Int. Cl. G06F 9/52

(52) U.S. Cl. CPC G06F 9/526

(57) ABSTRACT

A server having multiple processing units executes a machine-learning application that instantiates a plurality of worker processes that accept connections from client devices at a socket. To prevent excess contention and migration of the worker processes to different processing units, each worker process is specified to a subset of the processing units eligible to execute that respective worker process. The respective subsets for each worker process may be mutually exclusive and each worker process may be assigned a single processing unit eligible to execute that worker process. This enables significantly higher throughput for the worker processes by preventing normal process migration across the plurality of processing units.

### CROSS-REFERENCE TO RELATED APPLICATION

This application claims the benefit of provisional U.S. Application No. 63/541,963, filed Oct. 2, 2023, the contents of which is incorporated herein by reference in its entirety.

### BACKGROUND

This disclosure relates generally to effective deployment of machine-learning applications and more particularly to deploying machine-learning applications in client-server architectures with a plurality of processing units.

Real-time machine-learning (“ML”) applications, unlike typical web applications, are heavily reliant on computational processing with a high degree of computational complexity and few (or no) external requests. Upon receiving a request, the application performs a sequence of processing-intensive routines such as payload parsing, validation, feature engineering, model predictions, feature importance calculations, and so forth, all of which generally do not depend on resource calls beyond the server process memory.

In one example, a machine-learning application can process a single request in about 65-75 milliseconds executed on a single processing unit (e.g., a processor or central processing unit (CPU)). Assuming no system or resource contention, this means it might be expected to maintain approximately 70 ms latency until a throughput of about 14 requests per second (1000 ms/70 ms) with only 1 process executing the application, after which a higher throughput would result in higher latencies due to connections waiting in queue. In addition, additional processing units supporting additional workers may be expected to linearly grow the number of requests that can be processed per second, such that 1 worker process should support up to 14 requests per second (rps), 2 worker processes should support up to 28 rps, and so forth.

In practice, these worker processes may implement ML applications in various technologies, such as Python, using an HTTP server framework to deploy the application with multiple processes executing on multiple processors. However, these deployments often do not achieve the expected throughput. In certain experiments (with 64 processing units), the performance of the application on standard server implementations starts to degrade above a received request rate of throughput of 6 rps and exceeds 1 s latency after a throughput of 17 rps, regardless of how many worker processes are deployed for the application. This unexpected behavior yields low throughput for these AI applications deployed in client-server architectures and may lead to significant overprovisioning of servers or reduced efficiency of deployed systems. As real-time use cases can experience a wide range of request rates, from hundreds per day for larger adjudication tasks to millions smaller transaction scoring, it is essential to improve effective throughput of a ML application on server systems.

### SUMMARY

In many cases, the inefficient performance of these ML processes may be attributable to contention for processing unit time. That is, the worker processes of the ML application may be migrated from one processing unit of the server system to another processing unit as the operating system schedules execution of the various active processes to be executed. As a result, the worker process may incur significant overhead due to the transfer of the application's state and relevant data to another processing unit and other associated overhead. As additional worker processes are added, these worker processes may also be migrated to different processing units during execution of the worker process. In addition, this issue particularly occurs for ML applications (and not for other web server applications) because these applications typically require a relatively high amount of processing with few or no external calls. That is, the processing required by these applications is both high and affected by inefficient use of processing units.

To address this problem, rather than permit the worker processes to execute on any of the processing units (i.e., the plurality of processing units present on the server), a subset of the processing units are designated as eligible for processing each of the worker processes. For example, each worker process may be designated a single processing unit for processing that worker process. Further, the subset of processing units may be mutually exclusive, such that each worker process does not share a processing unit with another. While the operating system may still schedule other processes for execution on the processing units eligible for processing the worker processes, this approach reduces overhead associated with instruction and data migration of the worker processes to different processing units. In certain experimental results discussed below, specifying a subset of eligible processing units for the worker processes of the ML application increases throughput by five times relative to a baseline in which the worker processes may be processed by any processing units. This approach thus provides a simple way to increase throughput while also reducing compute costs on a single machine.

### BRIEF DESCRIPTION OF THE DRAWINGS

FIG. 1 illustrates an example environment for executing a machine-learning model application, according to one embodiment.

FIG. 2 shows an example timing diagram for assigning eligible processing units for worker processes, according to one embodiment.

FIG. 3 shows an example method for improving throughput of worker processes, according to one embodiment.

FIGS. 4-6 show plots of example response latency as a function of incoming user request rates according to different configurations.

FIG. 7 is a table summarizing measured statistics when assigning different configurations of eligible computing units.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

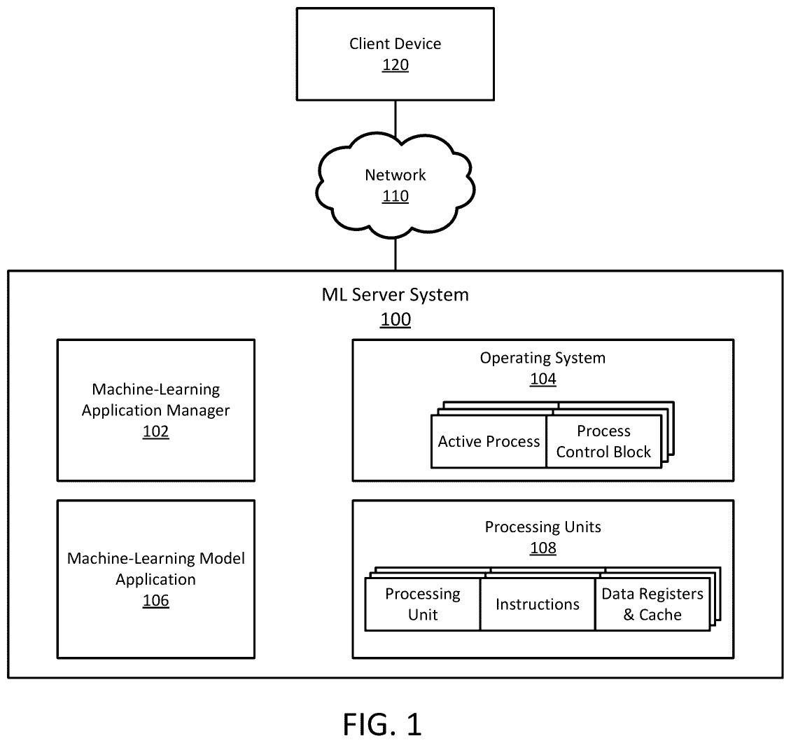

FIG. 1 illustrates an example environment for executing a machine-learning model application 106, according to one embodiment. In overview, a machine-learning (ML) server system 100 receives requests from a client device 120 via a network 110 for executing a ML application for the client device 120. Although one client device 120 is shown in FIG. 1, in practice, a large number of client devices 120 may provide requests for the ML server system 100. The particular type of requests and application provided by the ML server system 100 differ in various embodiments and configurations.

In general, the application provided by the ML server system 100 may implement a machine-learning model with parameters trained by a set of training data and may typically include thousands, millions, or billions of parameters to be applied by the model to process an input to a resulting output. Various additional analyses before and after application of the model may also be applied in different embodiments. For example, the input may be evaluated to determine whether it is suitable for application to the trained ML model (e.g., whether the input is of a similar distribution to the data used to train the model), and the output may be analyzed to determine feature importance to the output according to the model application or generate an individual conditional expectation (ICE) plot visualizing the effect of feature variation on the model input. In general, the machine-learned model application 106 may be relatively complex and computationally intensive, such that providing real-time inference (i.e., output predictions) in a timely way primarily depends on application of the model parameters to the input. Relative to many server-based applications, a ML model application 106 typically has relatively few database or other external functional calls, such that may process existing data for a relatively long period of time before requiring communication with or awaiting a reply from another system. As an example in the present disclosure, the ML application receives an input from the client device 120 and executing the ML model application 106 is expected to require approximately 65-75 milliseconds (ms) of processing by a processing unit.

Although the client device 120 and ML server system 100 are shown connected through a network 110 in FIG. 1, in additional embodiments, further systems may be disposed between these devices and are not shown for convenience. For example, an additional system may operate as a frontend that initially receives a request from the client device 120 and routes requests to a particular ML server system 100 from a plurality of ML server systems 100 configured to handle requests from client devices 120. In addition, live systems may also include load balancers and other networking components to smoothly provide handling for client requests.

The network 110 provides a communication channel between the client device 120 and ML server system 100. The network 110 may include wired and wireless communication channels and protocols, and in typical embodiments may implement network addressing and routing with any suitable technologies, such as network layer addressing with Internet Protocol (IP) addresses and transport layer protocols such as Transmission Control Protocol (TCP) or User Datagram Protocol (UDP). In general, the client device 120 sends a request to the ML server system 100 by specifying a destination network address, port, and transport protocol and including the network address and local port of the client device 120. The ML server system 100 may then establish connection to the client device 120 as a socket defined by the respective addresses, ports, and protocol through which data is sent and received between the client device 120 and ML server system 100.

The ML server system 100 includes a plurality of processing units 108 that are managed by an operating system 104. In various embodiments, the processing units 108 may include processors that primarily execute sequenced instructions, such as a central processing unit (CPU), and may include processors specialized for distributed or matrix operations, such as a graphics processing units (GPU). In the examples and experiments discussed below, the ML server system 100 includes sixty-four (64) CPUs as processing units 108 that may each be assigned a process to execute. In additional embodiments, the number and type of processing units 108 may differ.

Each processing unit 108 is generally configured to execute a process described by a set of instructions and operating on a set of data registers. Each processing unit 108 may also include various cache levels that describe proximity of the relevant data to the data registers operated on by the processing unit. For example, a “level 1” cache is typically closer to the processing unit than a “level 2” cache but is typically smaller in size. While processing the instructions, relevant data may be fetched and located at particular local data caches based on the frequency of data access or likelihood that an instruction will reference that data.

The operating system 104 manages the execution of a number of active processes by the processing units 108. Each process may be identified by a process identifier and the operating system 104 may maintain a set of data related to execution of the process, termed a process control block. The process control block may specify various types of information about the associated process that differs in various embodiments. This information may include a state of the process (running, waiting, terminated), register data (for waiting processes), memory allocation data, scheduling data (priority information) and so forth. The process control block may also maintain information about the amount of time a process has run on a processing unit 108 and the amount of time that a process may be paused (e.g., stalled) from running. That is, the amount of time that a process may be eligible to run but that the process has actually been scheduled to run. In particular, the process control block may also include a list of eligible processing units permitted to run each process. Typically, the operating system 104 designates all processes as eligible to run on all processing units. For typical server applications that may require relatively limited processing, execution by any processing unit 108 enables swift resolution of the client request, or a limited processing time is sufficient to reach a waiting point at which the process is blocked while for a call to another function or system. As discussed further below, this behavior for ML applications can lead to inefficient allocation of computing resources that lead to significantly reduced throughput relative to the expected throughput of an application.

The operating system 104 uses the information from the process control block to schedule execution of the active processes at the processing units 108. The particular assignment of an active process to a particular processing unit varies in different operating systems 104. In general, the operating system 104 may only assign the process to one of the eligible processing units specified in the process control block. The operating system 104 may also change which process is executing based on various priorities, such as the priority level of a process, how long a process has been waiting to execute, how long a process has been continuously executing, and to prevent processes from starving (i.e., “active” processes that receive zero processing for an excess amount of time).

The machine-learning application manager 102 initiates and manages execution of the machine-learning model application 106. In one embodiment, the ML application manager 102 is a script that may be initiated by the ML server system 100 on startup or when the ML server system 100 is signaled to receive user requests related to ML model application 106. The ML application manager 102 may instruct the operating system 104 to begin executing the machine-learning model application 106. In execution, the ML model application 106 may initiate additional processes for processing client requests, for example by requesting to fork the process from the operating system 104. The initial process started for the ML model application 106 may be referred to as a parent process, and additional process(es) may be referred to as worker process(es). The operating system 104 may then have a number of active processes associated with the ML model application 106. The ML application manager 102 instructs the operating system 104 to modify the eligible processing units for processes of the ML model application 106 as further discussed below.

### Worker Processes Associated with Subset of Computing Units

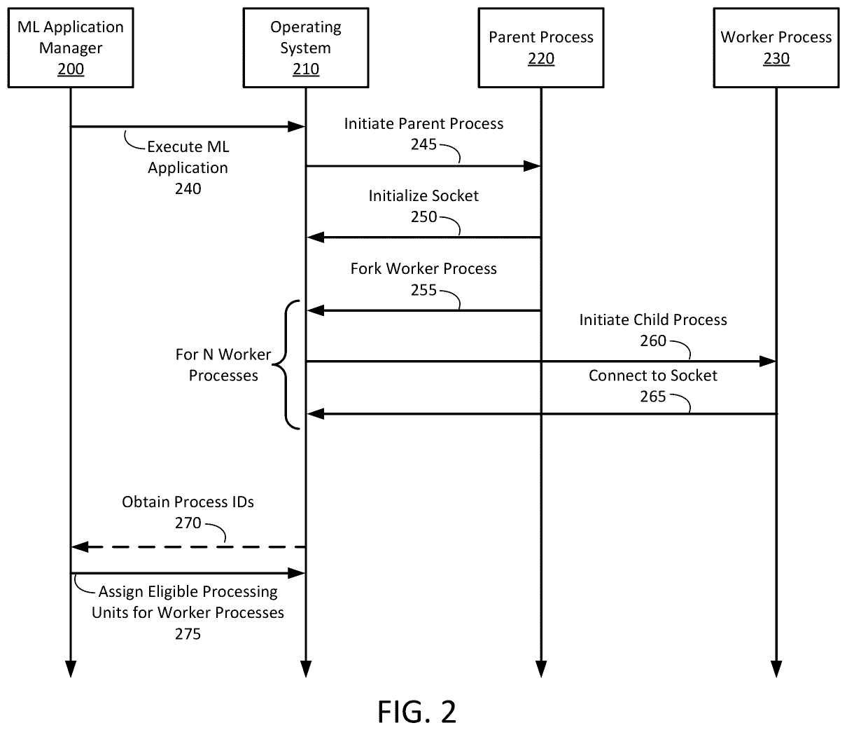

FIG. 2 shows an example timing diagram for assigning eligible processing units for worker processes, according to one embodiment. First, a process, such as a ML application manager 200, instructs an operating system 210 to execute 240 a ML application. The operating system initiates 245 the ML application by assigning a process identifier (PID) to the ML application. The initial process for the ML application is referred to in FIG. 2 as a parent process 220 as it typically creates a number of worker processes 230 that respond to user requests. As such, in some implementations, the parent process 220 and the worker process(es) 230 may together be considered components of the overall ML application. After initiating the parent process 220, the operating system 210 begins scheduling the ML application for execution on the eligible computing units associated with the PID of the parent process 220. In some embodiments, the parent process 220 is initiated 245 with a designation of all processing units being eligible for executing the parent process 220.

When the parent process 220 is executed, it initializes a socket 250 for use by the ML application. The initialization process may differ in various embodiments and different operating systems 210, and may include creating a socket with the operating system, binding the socket to an address and/or port and indicating that the socket is a listening/passive socket to receive incoming connection requests. Individual user requests are typically handled by a number of worker processes 230 that are initialized by the parent process 220 forking worker process 255 for the operating system 210 to initiate 260 a new child process that is configured to operate as a worker process 230. The worker process 230 may then connect 265 to the socket to accept incoming connection requests. When the worker process 230 is initiated with the socket created by the parent process 220, the worker process may inherit the same socket characteristics, enabling multiple worker processes 230 to receive requests from the same socket. Although not shown in FIG. 2, the parent process 220 may initiate 260 a plurality of worker processes 230 this way to handle further requests simultaneously with the various worker processes 230. When the worker process 230 requests to connect 265 to incoming requests for connection, the worker process may be blocked until a request is received at the socket for handling by the worker process.

In this example, the parent process 220 creates the worker processes 230 in advance of the receipt of a user connection (i.e., pre-forking the worker process 230); in other embodiments, the parent process 220 may connect to incoming requests for the socket and fork worker processes 230 (e.g., up to a maximum number of worker processes) as the requests are received.

When a request is received, the requested connection 265 is completed and the worker process 230 is unblocked and may process the request using the ML model. The unblocked process may then be executed on the eligible processing units. In some embodiments, after completing processing of a request, the worker process 230 connects 265 to receive another connection to a device.

In one or more embodiments, the ML application 200 assigns eligible processing units to the worker processes 230. In some embodiments, the ML application manager 200 may obtain 270 the process IDs from the operating system 210 for the worker processes 230 and/or parent process 220 to specify the process IDs for which the eligible processing units are assigned 275. The eligible processing units may be specified to the operating system 210 in various ways depending on the operating system 210 and may include calling the “taskset” function from the operating system 210. The operating system 210 may then apply the assigned processing units to the applicable worker processes 230.

The ML application manager 200 specifies a subset of the computing units for each worker process as the eligible computing units on which the worker process may be executed. In one embodiment, the eligible computing units are mutually exclusive subsets of the plurality of computing units on the system. In addition, in some embodiments, a single computing unit is assigned as the eligible computing unit for each worker process 230, such that each worker process 230 may execute only on the specified eligible computing unit. For example, a first worker process may be assigned to a first computing unit as the eligible computing unit, a second working process may be assigned to a second computing unit, and so forth. In this example, the number of worker processes may be the same as the number of computing units, such that there may be a one-to-one correspondence between each worker process and each computing unit. As such, when the operating system schedules execution of the various active processes, the worker processes 230 may be prevented from contending with one another for a particular computing unit and may also be prevented from migrating from one computing unit to another. As shown in the experimental examples below, when a large number of computing units are available for executing the worker processes, the ability to change processing of the worker processes to a large number of processing units, typically advantageous for online servers, becomes a hindrance to effective throughput.

In the example of FIG. 2, the parent process 220 and various worker processes 230 may initially be executed with a default set of eligible computing units, such as all computing units of the server system. As such, the worker processes 230 may initially be scheduled by the operating system 210 for execution by the default set of eligible computing units, which may be used to handle initial connections. In this example, after the processes are instantiated, the eligible computing units may be assigned 275 for each worker process 230 one or more initial connections are processed by the worker process 230. In other embodiments, the eligible computing units are assigned before execution of the worker process 230.

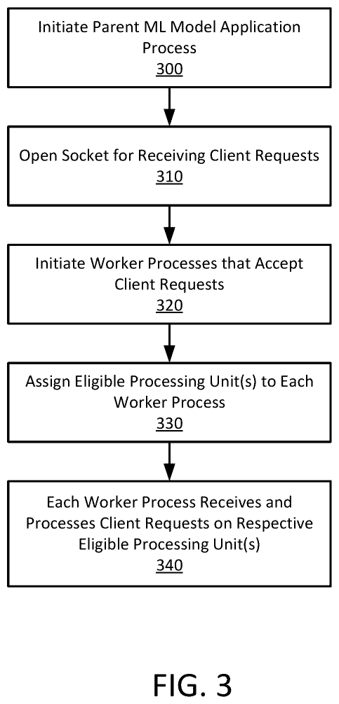

FIG. 3 shows an example method for improving throughput of worker processes, according to one embodiment. As discussed above, the ML application may be initiated 300 as a parent process. The parent process may then open a socket 310 for receiving client requests as discussed. Worker processes are then initiated 320 that may have separate PIDs from the parent process of the ML application and inherit the socket structure to accept connections for the socket when client requests are received. Each of the worker processes is then assigned a subset of all processing units as the eligible processing units for executing the respective worker process as discussed above. Subsequently, each worker process receives and processes 340 client requests from the socket and is executed on the respective subset of eligible processing units.

### Experimental Results

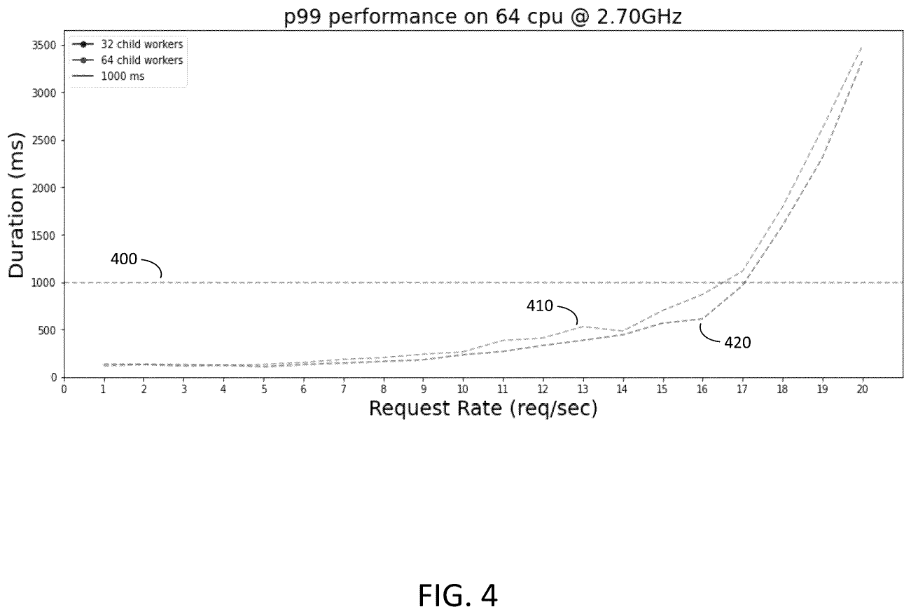

FIGS. 4-6 show plots of example response latency as a function of incoming user request rates according to different configurations. In the examples of FIGS. 4-6, a computing system has 64 CPUs that are the computing units on which processes may be executed. The plots of FIGS. 4-6 show example response latency, measured as the 99^{th} percentile (p99) of response times (i.e., 99% of requests for the ML application are processed within that response latency or less). In these examples, a single application of the ML application is expected to require approximately 65-75 milliseconds when executed on a single computing unit (one CPU at 2.70 GHz).

In the example of FIG. 4, latency is shown for a different number of working processes as the request rate increases. A reference line 400 indicates a one-second (1000 millisecond) latency from received request to returned result. In the configuration of FIG. 4, all workers are eligible to be executed on any (i.e., all) of the plurality of processing units. A first line 410 shows the p99 latency for 32 worker processes, each eligible to execute on any of the 64 computing units. A second line 420 shows the p99 latency for 64 worker processes, each eligible to execute on any of the 64 computing units. The experimental results shown in FIG. 4 illustrate the surprisingly low throughput when the worker processes are eligible to execute in the default configuration of all computing units. Although the worker processes are doubled from 32 to 64, the second line 420 shows relatively limited improvement relative to the first line 410.

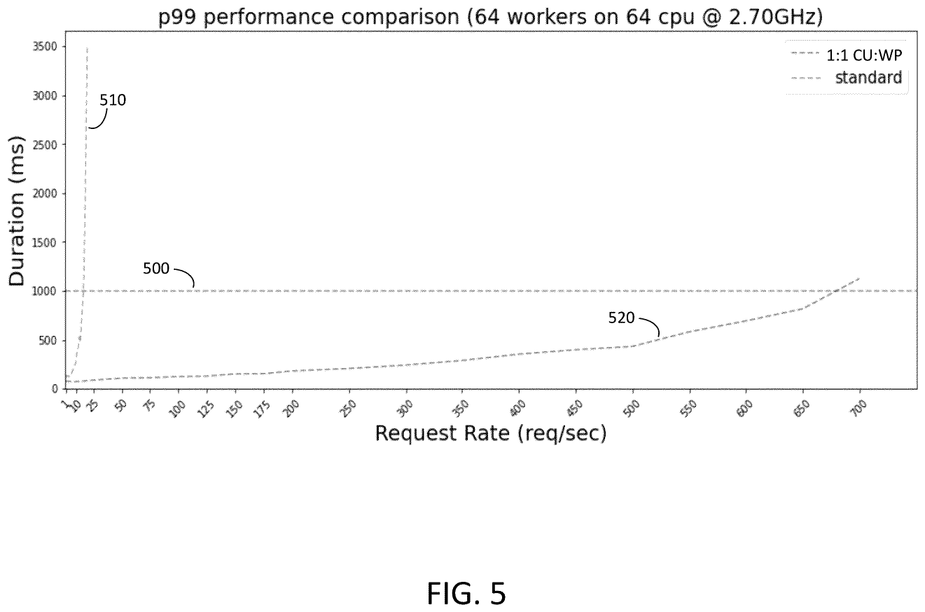

FIG. 5 shows an example performance improvement for 64 worker processes when all computing units are eligible to execute the processes and when a single computing unit is assigned to each worker process (labeled “1:1 CU:WP” in FIG. 5).

The application running on default computing unit eligibility breaches the 1000 ms p99 response time 500 at just 17 requests per second as shown by a first line 510. In stark contrast, assigning a one-to-one assignment of computing unit to worker process does not breach the 1000 ms response time as shown by a second line 520 until between 650-700 requests per second. This means that the same application running on the same system can realize a 38× (650/17) higher throughput with this optimization.

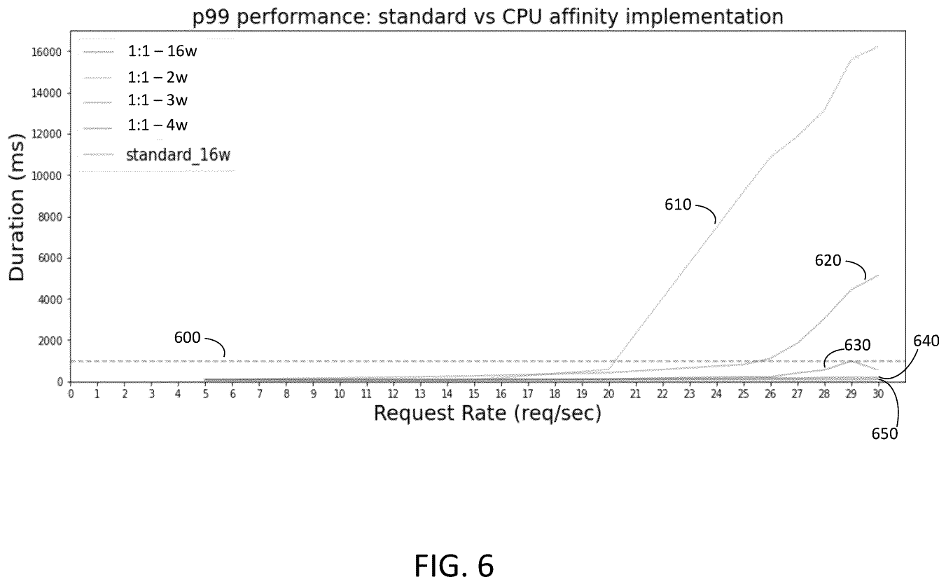

FIG. 6 shows a similar benefit when running fewer worker processes. In this example experiment, performance of the application running on 2, 3, 4, and 16 worker processes are compared with the baseline (all eligible computing units) of the application under the standard implementation running on 16 worker processes. The baseline application running on default computing unit eligibility as shown by a first line 620 breaches the 1000 ms p99 response time 600 at 26 requests per second, while assigning one-to-one eligible computing unit to worker process breaches the 1000 ms p99 response time between a second line 620 showing two worker processes and a third line 630 showing three worker processes. Meanwhile, assigning 1:1 computing units for four worker processes shown by a fourth line 640 or sixteen worker processes shown by a fifth line 650 remain at a low response time at 30 requests per second. This plot shows that the application under the new implementation can roughly match the performance of the same application under the standard implementation on 5× (16/3) fewer worker processes.

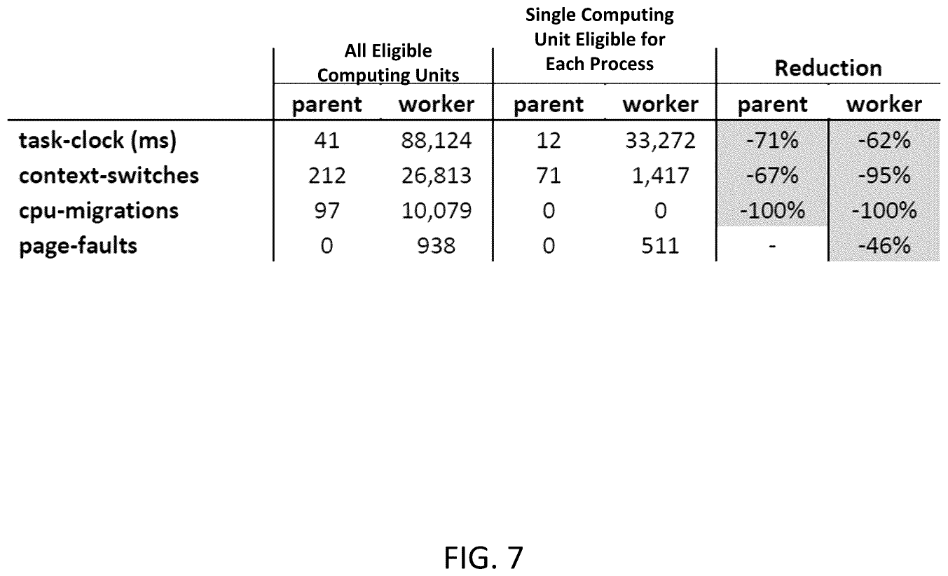

FIG. 7 is a table summarizing measured statistics when assigning different configurations of eligible computing units. The table of FIG. 7 compares 4 system performance counters under two scenarios; application with 4 worker processes running on the default (standard) computing unit eligibility and the same application with 4 worker processes running on assigned computing units (i.e., a one-to-one assignment of computing unit to worker process). For each configuration, 1,000 requests were sent to the application at a rate of 25 requests per second and system performance was profiled according to various performance counters.

The task-clock performance counter represents the total CPU time (ms) that the PID utilized while in running state during its lifetime. In this case, the runtime of the assigned worker processes in processing all 1,000 requests required 62% less CPU time under the new method.

The context-switches performance counter represents how many times a PID was swapped from running state by the process scheduler during its lifetime. In this case, there were 95% less context switches under the new method. This may be a significant driver of performance degradation in the standard method because context switches are “pure overhead” as computing unit cycles are spent on the process of saving and loading a PID's context variables and swapping it to and from states (running, waiting, ready) rather than doing useful work for the application.

The cpu-migrations performance counter represents total number of times a PID was migrated to a different CPU during a context switch throughout its lifetime. It is not surprising that the new method shows 0 migrations because each PID is eligible to be run only on its own computing unit. However, this can also be another significant driver of performance degradation in the standard method because when the process scheduler swaps a PID out from ready state back to running state onto a new computing unit, that computing unit generally does not have that PID's instructions & data in its local caches (L0-L1). In this case there would be a cache miss, and data needs to be read from higher level caches (L2-L4) or worst case from disk. These cache misses add significant latency. With the new method, the data & instruction are guaranteed to be in the local caches and hence this locality speeds up the runtime.

The page-faults performance counter indicates when the data required by the process is not in main memory (L4) and had been paged out to disk by the virtual memory (VM) system earlier and needs to be paged in. Paging in from disk is significantly slower than fetching from memory and hence adds latency. The new method experiences 46% less page faults.

Accordingly, assigning computing units to worker processes is a system level configuration that is cheap to implement and provides surprising improvement to implementations that allow workers to execute on any computing unit in a multi-computing unit environment. As shown in the specific experiments above, this optimization was able to increase throughput for our application by 38× over the baseline on the same amount of resources, or alternatively match the throughput of the baseline on only 20% of the resources required by the baseline application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for executing machine-learning processes, comprising:
a plurality of processing units each configured to execute one or more processes based on instructions;
a computer-readable medium having instructions for execution on the plurality of processing units for:
initiating a machine-learning parent process that opens a socket for receiving client requests to apply a machine-learned model;
initiating, by the machine-learning parent process, a plurality of worker processes that accept requests for the socket and apply the machine-learned model to received requests; and
for each of the plurality of worker processes, assigning a set of eligible processing units for executing the respective worker process that consists of a subset of the plurality of processing units.

2. The system of claim 1, wherein the eligible subset of the processing units is set in a process control block of an operating system of the system.

3. The system of claim 1, wherein the eligible subset of the processing units consists of a single processing unit of the plurality of processing units.

4. The system of claim 1, wherein the eligible subset of the processing units set for each of the plurality of worker processes is mutually exclusive.

5. The system of claim 1, wherein setting the eligible subsets of the processing units is performed and each worker process has accepted a request for the socket.

6. The system of claim 1, wherein a number of the plurality of worker processes is the same as a number of the plurality of processing units.

7. The system of claim 1, further comprising executing each of the plurality of worker processes with the respective eligible subset of processing units.

8. The system of claim 1, wherein the plurality of worker processes are initiated with a default set of eligible processing units specifying the plurality of processing units.

9. A method for executing a machine-learning process in a system having a plurality of processing units, comprising:
initiating a machine-learning parent process that opens a socket for receiving client requests to apply a machine-learned model;
initiating, by the machine-learning parent process, a plurality of worker processes that accept requests for the socket and apply the machine-learned model to received requests; and
for each of the plurality of worker processes, assigning a set of eligible processing units for executing the respective worker process that consists of a subset of the plurality of processing units.

10. The method of claim 9, wherein the eligible subset of the processing units is set in a process control block of an operating system of the system.

11. The method of claim 9, wherein the eligible subset of the processing units consists of a single processing unit of the plurality of processing units.

12. The method of claim 9, wherein the eligible subset of the processing units set for each of the plurality of worker processes is mutually exclusive.

13. The method of claim 9, wherein setting the eligible subsets of the processing units is performed each and worker process has accepted a request for the socket.

14. The method of claim 9, wherein a number of the plurality of worker processes is the same as a number of the plurality of processing units.

15. The method of claim 9, further comprising executing each of the plurality of worker processes with the respective eligible subset of processing units.

16. The method of claim 9. wherein the plurality of worker processes are initiated with a default set of eligible processing units specifying the plurality of processing units.

17. A non-transitory computer-readable storage medium for comprising instructions executable, by one or more processing units of a system having a plurality of processing units, for:
initiating a machine-learning parent process that opens a socket for receiving client requests to apply a machine-learned model;
initiating, by the machine-learning parent process, a plurality of worker processes that accept requests for the socket and apply the machine-learned model to received requests; and
for each of the plurality of worker processes, assigning a set of eligible processing units for executing the respective worker process that consists of a subset of the plurality of processing units.

18. The non-transitory computer-readable storage medium of claim 17, wherein the eligible subset of the processing units is set in a process control block of an operating system.

19. The non-transitory computer-readable storage medium of claim 17, wherein the eligible subset of the processing units consists of a single processing unit of the plurality of processing units.

20. The non-transitory computer-readable storage medium of claim 17, wherein the eligible subset of the processing units set for each of the plurality of worker processes is mutually exclusive.
